(19) United States
(12) Patent Application Publication
(10) Pub. No.: US 2014/0322533 A1
(43) Pub. Date: Oct. 30, 2014

(54) ELECTRICALLY INSULATED WIRE

(71) Applicant: Yazaki Corporation, Tokyo (JP)

(72) Inventor: Shuichi KIMURA, Susono-shi (JP)

(73) Assignee: YAZAKI CORPORATION, Tokyo (JP)

(21) Appl. No.: 14/260,998

(22) Filed: Apr. 24, 2014

(30) Foreign Application Priority Data
Apr. 24, 2013 (JP) 2013-091052

(51) Int. Cl. H01B 3/30

(52) U.S. Cl. CPC H01B 3/301
USPC 428/383

(57) ABSTRACT

An electrically insulated wire includes a conductor and an insulating layer having an inner layer which coats an outer circumference of the conductor and an outer layer which coats an outer circumference of the inner layer. The outer layer contains a polyphenylene sulfide resin and the inner layer contains a polyphenylene ether resin and an olefin resin. An average thickness of the outer layer is 50% or less of a thickness of the entire insulating layer.

### CROSS-REFERENCE TO RELATED APPLICATIONS

The present application claims priority to and incorporates by reference the entire contents of Japanese Patent Application No. 2013-091052 filed in Japan on Apr. 24, 2013.

### BACKGROUND OF THE INVENTION

1. Field of the Invention

The present invention relates to an electrically insulated wire. More particularly, the present invention relates to an electrically insulated wire which is easily produced and has excellent heat resistance and abrasion resistance.

2. Description of the Related Art

Electrically insulated wires include a conductor which carries electricity and an insulating layer which prevents leakage of electricity to the surroundings of the conductor. In many conventional electrically insulated wires, a conductor has been coated with a plurality of insulating layers and furthermore, for example, plastics such as polyester and nylon have been used as a main insulating layer. However, materials of an insulating layer for conventional heat-resistant electric wires had a problem in that sufficient heat resistance was not obtained unless the material of an insulating layer was subjected to the crosslinking treatment such as electron beam irradiation after extrusion molding of a coating layer. Such crosslinking treatment had problems of requirement of expensive electron beam irradiation devices and the like as well as decreased production efficiency due to the additional crosslinking treatment process. Accordingly, materials which satisfy desired characteristics without requiring the crosslinking treatment have been needed.

Conventionally, an electrically insulated wire using a polyphenylene sulfide resin composition as an insulating layer has been disclosed (see, for example, Japanese Patent Application Laid-open No. 62-143307). The polyphenylene sulfide resin (PPS resin) satisfies desired heat resistance without performing the crosslinking treatment. However, the PPS resin, which is expensive, increases the cost when the PPS resin is used in the entire insulating layer. For this reason, an electrically insulated wire having an insulating layer with a two-layer structure using the PPS resin for an outer layer and a polyolefin resin for an inner layer has been disclosed (see, for example, Japanese Patent Application Laid-open No. 2009-301777).

The insulating layer of Japanese Patent Application Laid-open No. 2009-301777, however, had a large difference in melting point between the material of the outer layer and the material of the inner layer. Accordingly, the melt viscosity of the inner layer material was significantly decreased in the head of an extruder set at high temperatures to melt the outer layer material, thereby extruding the electrically insulated wire with the conductor being shifted from the center of the electric wire. As a result, the conductor was not uniformly coated with the inner layer and the outer layer, which posed a risk of damaging the conductor when removing the insulating layer from the electric wire. In addition, the conductor was not uniformly coated with the insulating layer, which posed a risk of decreasing abrasion resistance.

### SUMMARY OF THE INVENTION

The present invention has been made in view of such problems of conventional techniques. It is an object of the present invention to provide an electrically insulated wire which has excellent heat resistance as well as excellent abrasion resistance without requiring an electron beam irradiation process during the production of the electrically insulated wire.

According to the first aspect of the present invention, an electrically insulated wire includes a conductor; and an insulating layer having an inner layer which coats an outer circumference of the conductor and an outer layer which coats an outer circumference of the inner layer, wherein the outer layer contains a polyphenylene sulfide resin, the inner layer contains a polyphenylene ether resin and an olefin resin, and an average thickness of the outer layer is 50% or less of a thickness of the entire insulating layer.

According to the second aspect of the present invention, in the electrically insulated wire, a mixing ratio of the polyphenylene ether resin to the olefin resin in the inner layer is 20 to 80:80 to 20 by weight.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are schematic diagrams illustrating an electrically insulated wire according to an embodiment of the present invention, where FIG. 1A is a cross-sectional view of the electrically insulated wire and FIG. 1B is a perspective view of the electrically insulated wire.

### DETAILED DESCRIPTION OF THE PREFERRED EMBODIMENTS

An embodiment of the present invention will be described below in detail with reference to the drawings. It is noted that the dimension ratio of the drawings is exaggerated for convenience of explanation and may differ from the actual ratio.

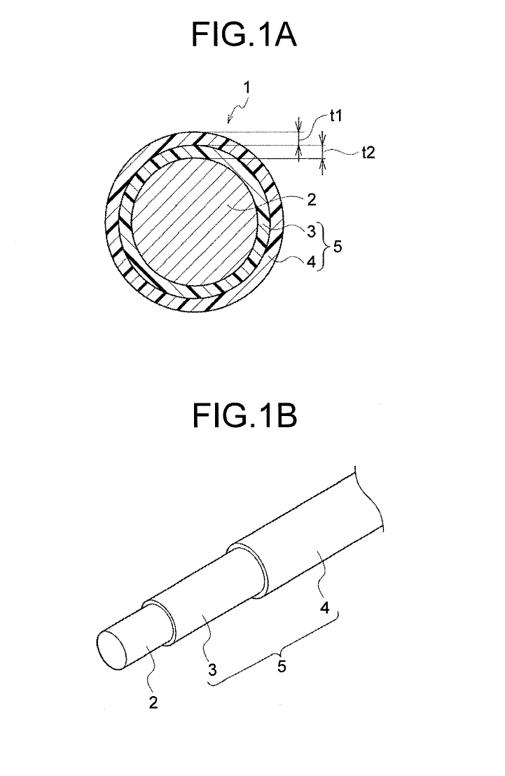

An electrically insulated wire 1 according to the embodiment of the present invention includes a conductor 2 as shown in FIGS. 1A and 1B. In addition, the electrically insulated wire 1 includes an insulating layer 5 including an inner layer 3 which coats an outer circumference of the conductor 2 and an outer layer 4 which coats an outer circumference of the inner layer 3.

The conductor 2 may include only a single wire or may include bundles of wires. For the conductor 2, the diameter and the material of the conductor are not particularly limited and can be appropriately set according to the application. As the material of the conductor 2, known conductive metal materials such as copper, copper alloys, aluminum, and aluminum alloys can be used.

The inner layer 3 contains a polyphenylene ether resin (hereinafter, also referred to as a PPE resin) and an olefin resin. The PPE resin contains as a main component poly (2,6-dimethylphenylene oxide) which can be synthesized by an oxidation polymerization method (oxidative coupling method) using 2,6-xylenol as a raw material.

As the PPE resin, a resin composed only of the PPE resin, poly (2,6-dimethylphenylene oxide), may be used but the PPE resin alone may fail to provide sufficient molding processability (particularly, melt fluidity). Accordingly, modified polyphenylene ether (m-PPE), which is a polymer alloy obtained by mixing or chemically bonding the PPE resin and/to other synthetic resins (for example, polystyrene, polyamide, ABS resin, or polyphenylene sulfide), is preferably used.

Examples of olefin resins include polyethylene-based resins and polypropylene-based resins. Examples of polyethylene-based resins include resins containing 50 mol % or more of an ethylene component unit, specifically high density polyethylene, low density polyethylene, linear low density polyethylene, ethylene-vinyl acetate copolymer, ethylene-propylene copolymer, ethylene-propylene-butene-1 copolymer, ethylene-butene-1 copolymer, ethylene-hexene-1 copolymer, ethylene-4-methylpentene-1 copolymer, and ethylene-octene-1 copolymer, and also mixtures thereof.

Examples of polypropylene-based resins include propylene homopolymer and copolymers of propylene and components such as other olefins copolymerizable with propylene. Examples of other olefins copolymerizable with propylene include α-olefins such as ethylene, 1-butene, isobutylene, 1-pentene, 3-methyl-1-butene, 1-hexene, 3,4-dimethyl-1-butene, 1-heptene, and 3-methyl-1-hexene.

The outer layer 4 contains a polyphenylene sulfide resin (hereinafter, also referred to as a PPS resin). As the polyphenylene sulfide resin, resins containing as a main component polyphenylene sulfide (polymer represented by the formula (—C₆H₄—S—)ₙ) can be used. Specifically, as the PPS resin, resins containing 50 mol % or more, preferably 60 mol % or more, more preferably 70 mol % or more of polyphenylene sulfide can be used.

As the PPS resin, a resin composed only of polyphenylene sulfide may be used. In order to improve fluidity, polymer alloys obtained by mixing or chemically bonding polyphenylene sulfide and/to other synthetic resins (for example, fluorine resin) can be used.

In the electrically insulated wire 1 of the present embodiment, the inner layer 3 thus contains the PPE resin and the olefin resin. The inclusion of the PPE resin can decrease the difference in melting point between the material of the inner layer 3 and the material of the outer layer 4 and accordingly allows the conductor to be located at the substantial center of the electric wire in the production of the electric wire, so that the conductor can be coated with the inner layer and the outer layer uniformly. Therefore, this can improve abrasion resistance and heat aging resistance. Furthermore, the inner layer 3 contains not only the PPE resin but also the olefin resin to provide high flexibility. The PPE resin and the olefin resin are preferably main components in the inner layer 3 from the viewpoint of ensuring high abrasion resistance, heat aging resistance, and flexibility. Specifically, the total amount of the PPE resin and the olefin resin contained in the inner layer 3 is preferably 50 mol % or more, and more preferably 70 mol % or more.

Moreover, in the electrically insulated wire 1 of the present embodiment, the outer layer 4 contains the polyphenylene sulfide resin, making it possible to ensure high heat resistance and liquid resistance. It should be noted that the polyphenylene sulfide resin is preferably a main component in the outer layer 4 from the viewpoint of ensuring sufficient heat resistance and liquid resistance. Specifically, the amount of the polyphenylene sulfide resin contained in the outer layer 4 is preferably 50 mol % or more, more preferably 60 mol % or more, and still more preferably 70 mol % or more.

However, since the polyphenylene sulfide resin has low flexibility, the outer layer 4 is preferably thinner in order to ensure the flexibility of the entire electrically insulated wire 1. Accordingly, the average thickness t1 of the outer layer 4 needs to be equal to or less than 50% of the thickness of the entire insulating layer 5 (equal to the average thickness t1 of the outer layer+the average thickness t2 of the inner layer). The average thickness of the outer layer 4 is preferably equal to or less than 40%, more preferably equal to or less than 30% of the thickness of the entire insulating layer 5. This case can further improve the flexibility of the entire electrically insulated wire 1. Although the lower limit of the average thickness of the outer layer 4 is not particularly limited, the average thickness of the outer layer 4 is preferably equal to or more than 10% of the thickness of the entire insulating layer 5 from the viewpoint of ensuring sufficient heat resistance and abrasion resistance.

It is noted that the thickness of the insulating layer in 0.35 sq electric wire according to ISO 6722-1 standards is nominally 0.25 mm. When the insulating layer of the present embodiment is applied to this electric wire, the thickness of the outer layer is preferably 0.125 mm or less. The thickness of the outer layer of more than 0.125 mm causes low flexibility and increases the cost, possibly preventing practical use.

As described above, the inner layer 3 contains the PPE resin and the olefin resin. In the inner layer 3, the mixing ratio of the PPE resin to the olefin resin is preferably 20 to 80:80 to 20 by weight. Even if the mixing ratio of the PPE resin to the olefin resin falls outside this range, the effects of the present invention can be exhibited. However, there is a risk of low abrasion resistance and heat aging resistance with less than 20 parts by weight of the PPE resin, or a risk of low flexibility with more than 80 parts by weight of the PPE resin. Moreover, there is a risk of low flexibility with less than 20 parts by weight of the olefin resin, or a risk of decreased concentricity and heat aging resistance with more than 80 parts by weight of the olefin resin. From the viewpoint of improving the abrasion resistance, heat aging resistance, and flexibility, the PPE resin is preferably from 30 to 60 parts by weight. From the same viewpoint, the olefin resin is preferably from 20 to 40 parts by weight.

In addition to the above essential components, the electrically insulated wire according to the present embodiment may contain other components without impairing the effects of the present invention. The electrically insulated wire according to the present embodiment may contain, for example, a flame retardant, a flame retardant auxiliary agent, an antioxidant, a metal deactivator, an anti-aging agent, a lubricant, a filler, a reinforcing material, a UV absorber, a stabilizer, a plasticizer, a pigment, a dye, a colorant, an antistatic agent, a foaming agent, and the like.

A plurality of the electrically insulated wires are bundled to provide a wire harness. To the end of the electrically insulated wire, for example, a connector can be attached.

Next, a method for producing the electrically insulated wire according to the present embodiment will be described. The inner layer 3 and the outer layer 4 of the electrically insulated wire 1 are prepared by kneading the above materials, and the preparation method thereof can be conducted using known means. For example, the above materials are pre-blended with a high-speed mixer such as a Henschel mixer and then kneaded with a known kneading machine such as a Banbury mixer, a kneader, and a roll mill to provide a resin composition for forming the inner layer 3 and the outer layer 4.

In the electrically insulated wire of the present embodiment, a method for coating the conductor 2 with the inner layer 3 and the outer layer 4 can also be conducted using known means. For example, both the inner layer 3 and the outer layer 4 can be formed by an ordinary extrusion molding method. As an extruder used in the extrusion molding method, for example, a single screw extruder and a twin screw extruder can be used, and specifically those having a screw, a breaker plate, a crosshead, a distributor, a nipple, and a die can be used.

For example, in preparing the resin composition of the inner layer 3, the PPE resin and the olefin resin are charged into a twin screw extruder set at a temperature sufficient to melt the PPE resin and the olefin resin. At this time, other components such as a flame retardant, a flame retardant auxiliary agent, and an antioxidant are also introduced if necessary. The PPE resin and the olefin resin are then melted and kneaded with a screw, and a given amount is supplied to a crosshead via a breaker plate. The melted PPE resin and olefin resin are run into the circumference of a nipple by a distributor and extruded by a die while coating the conductor, thereby providing the inner layer 3 coating the conductor 2.

The outer layer 4 can also be formed using an extruder in the same manner as described above. From the viewpoint of improving the productivity, an extruder for the inner layer 3 and an extruder for the outer layer 4 are preferably used in combination to form the inner layer 3 and the outer layer 4 by coextrusion.

In the electrically insulated wire of the present invention, the insulating layer can thus be formed by extrusion in the same manner as with ordinary resin compositions for electric wires. Since the crosslinking process by irradiation of electron beam or the like after extrusion molding is unnecessary, the production efficiency can be increased.

### EXAMPLES

Examples of the present invention will be described below in more detail by way of Examples and Comparative Examples, but the present invention is not limited to these Examples.

### Sample Preparation in Examples and Comparative Examples

### Preparation of Resin Compositions for Inner Layer and Outer Layer

Materials for the inner layer and the outer layer as shown in Table 1 were prepared. Resin compositions for the inner layer in Examples and Comparative Examples each were prepared by mixing the materials at the proportions shown in Table 2 using a twin screw extruder. For the resin compositions for the outer layer in Examples 1 to 4 and Comparative Examples 2, 4, and 5, the PPS alloy in Table 1 was used as it was.

TABLE 1

| | Material Name | Product Name | Manufacturer |
|---|---|---|---|
| Material for | PPS Alloy | FZ-2100 | DIC |
| Outer Layer | | | Corporation |
| Material for | m-PPE | PX-100L | Mitsubishi |
| Inner Layer | | | Engineering- |
| | | | Plastics |
| | | | Corporation |
| | Polypropylene | E111G | Prime |
| | | | Polymer Co., |
| | | | Ltd. |

### Production of Electrically Insulated Wire

### Examples 1 to 4 and Comparative Examples 2, 4, and 5

Electrically insulated wires coated with the inner layer and the outer layer were produced using the resin compositions for the inner layer and for the outer layer in respective Examples and Comparative Examples which were prepared as described above. Specifically, the inner layer and the outer layer were formed around the conductor by coextrusion of the inner layer and the outer layer using two extruders. During the coextrusion, the extrusion temperature of the die part in the extruder for the inner layer was set to 250° C., and the extrusion temperature of the die part in the extruder for the outer layer was set to 310° C. Annealed copper was used as a material of the conductor, and furthermore the size of the ISO conductor was 0.35 mm².

In the obtained electrically insulated wires of respective Examples and Comparative Examples, the entire surface of a core wire (19 strand wires) of 0.15 mm diameter was coated with the inner layer and the outer layer. The average total thickness of the inner layer and the outer layer was 0.25 mm, and the outer diameter of the electrically insulated wire was 1.3 mm. The average thicknesses of the inner layer and the outer layer in respective Examples and Comparative Examples are also shown in Table 2.

### Comparative Examples 1 and 3

Electrically insulated wires coated only with the inner layer were produced using the resin compositions for the inner layer in Comparative Examples 1 and 3 which were prepared as described above. Specifically, only the inner layer was formed around the conductor by extrusion using an extruder. During the extrusion, the extrusion temperature of the die part in the extruder was set to 250° C. The conductor used was the same as described above.

In the obtained electrically insulated wires of respective Comparative Examples 1 and 3, the entire surface of a core wire (19 strand wires) of 0.15 mm diameter was coated only with the inner layer. The average thickness of the inner layer was 0.25 mm, and the outer diameter of the electrically insulated wire was 1.3 mm.

TABLE 2

| | | | Inner Layer | | |
|---|---|---|---|---|---|
| | Outer Layer | | | Polypro- | |
| | PPS Alloy | Average | m-PPE | pylene | Average |
| | (parts by | Thickness | (parts by | (parts by | Thickness |
| | weight) | (mm) | weight) | weight) | (mm) |
| Example 1 | 100 | 0.10 | 20 | 80 | 0.15 |
| Example 2 | 100 | 0.10 | 60 | 40 | 0.15 |
| Example 3 | 100 | 0.10 | 80 | 20 | 0.15 |
| Example 4 | 100 | 0.06 | 60 | 40 | 0.19 |
| Compara- | — | — | 100 | — | 0.25 |
| tive | | | | | |
| Example 1 | | | | | |
| Compara- | 100 | 0.10 | 100 | — | 0.15 |
| tive | | | | | |
| Example 2 | | | | | |
| Compara- | — | — | 40 | 60 | 0.25 |
| tive | | | | | |
| Example 3 | | | | | |
| Compara- | 100 | 0.10 | — | 100 | 0.15 |
| tive | | | | | |
| Example 4 | | | | | |
| Compara- | 100 | 0.13 | 60 | 40 | 0.12 |
| tive | | | | | |
| Example 5 | | | | | |

### Evaluation

The electrically insulated wires obtained in Examples and Comparative Examples as described above were evaluated for concentricity, liquid resistance, abrasion resistance, flexibility, fusing properties, and heat aging resistance by the following methods.

### Concentricity

Concentricity refers to the value indicating how close to the center the conductor is in the cross-section of the electric wire and represents whether the insulating layer can be peeled without damaging the conductor. The cross-section of the electric wires obtained in Examples and Comparative Examples was observed under an optical microscope, and the concentricity was calculated from the following equation. The concentricity was evaluated as “good” for 80% or more, or “poor” for less than 80%.

Concentricity=(the minimum thickness of the insulating layer)/(the thickness of the insulating layer diametrically opposite to the point where the thickness of the insulating layer is minimum)×100

### Liquid Resistance

The liquid resistance was examined according to ISO 6722-1, Liquid resistance, Test method 2 and evaluated as “good” when the maximum change rate of the electric wire outer diameter was less than 5%, or “poor” for 5% or more.

### Abrasion Resistance

The scrape test was conducted according to ISO 6722-1 and the abrasion resistance was evaluated as “good” when the number of times of abrasion was 150 or more, “moderate” for 100 or more and less than 150, or “poor” for less than 100.

### Flexibility

The electric wires obtained in Examples and Comparative Examples were cut into 10 cm pieces and the cut pieces were subjected to a three-point bending test to measure the value of the maximum stress. The flexibility was evaluated as “good” when the load applied to the center of the electric wire was less than 0.45 N, or “poor” for 0.45 N or more.

### Fusing Properties

According to JASO D618 5.8.3, Heat resistance test 1C, the electric wires obtained in Examples and Comparative Examples were wound 6 turns around a mandrel having a diameter equal to the outer diameter of the electric wire and heated in an aging tub at 200° C. for 30 minutes. After that, the presence of cracks on the surface of the insulating layer was visually inspected. In addition, the electric wire after heating was removed from the mandrel, and occurrence of fusion between adjacent parts of the electric wire and exposure of the conductor were visually inspected. The fusing properties were evaluated as “good” when no crack or fusion of the insulating layer or exposure was observed, or “poor” when they were observed.

### Heat Aging Resistance

The electric wires obtained in Examples and Comparative Examples were maintained in an oven at 150° C. for 1,000 hours. The electric wires were then taken out of the oven and wound around a rod having the same diameter as the electric wire. The presence of cracks in the insulating layer was visually inspected, and the heat aging resistance was evaluated as “good” when no crack was observed in the insulating layer, or “poor” when cracks were observed.

The evaluation results of the concentricity, liquid resistance, abrasion resistance, flexibility, fusing properties, and heat aging resistance are shown in Table 3. This table shows that the electric wires of Examples 1 to 4 encompassed by the present invention are excellent in all evaluations of concentricity, liquid resistance, abrasion resistance, flexibility, fusing properties, and heat aging resistance.

TABLE 3

| | | | | | | Heat |
|---|---|---|---|---|---|---|
| | | Liquid | Abrasion | | Fusing | Aging |
| | Concentricity | Resistance | Resistance | Flexibility | Properties | Resistance |
| Example 1 | Good | Good | Moderate | Good | Good | Good |
| Example 2 | Good | Good | Good | Good | Good | Good |
| Example 3 | Good | Good | Good | Good | Good | Good |
| Example 4 | Good | Good | Good | Good | Good | Good |
| Comparative | Good | Poor | Good | Poor | Good | Poor |
| Example 1 | | | | | | |
| Comparative | Good | Good | Good | Poor | Good | Poor |
| Example 2 | | | | | | |
| Comparative | Good | Poor | Good | Good | Poor | Good |
| Example 3 | | | | | | |
| Comparative | Poor | Good | Poor | Good | Good | Poor |
| Example 4 | | | | | | |
| Comparative | Good | Good | Good | Poor | Good | Good |
| Example 5 | | | | | | |

However, the electric wires of Comparative Examples 1 and 3 with no outer layer made of the PPS resin are shown to have poor liquid resistance. Moreover, Comparative Examples 1 and 2 show that the electric wires with no olefin resin in the inner layer have poor flexibility. Comparative Example 4 shows that the electric wire with no PPE resin contained in the inner layer has a large difference in melting point between the outer layer and the inner layer and thus has lower concentricity to cause poor abrasion resistance and poor heat aging resistance. Furthermore, Comparative Example 5 shows that the electric wire in which the thickness of the outer layer is more than 50% of the thickness of the entire insulating layer has poor flexibility.

Although the present invention is described above by way of Examples, the present invention is not limited to these Examples and various modifications can be made within the scope of the present invention. That is, in the above embodiment, the example in which the insulating layer includes two layers of the inner layer and the outer layer is illustrated, but the insulating layer may further include other layers to have three or more layers. As described above, however, the electrically insulated wire of the present invention can exhibit high durability even with the insulating layer including only two layers of the inner layer and the outer layer.

In the electrically insulated wire of the present invention, a conductor is coated with an insulating layer including an inner layer and an outer layer. The outer layer contains a polyphenylene sulfide resin and the inner layer contains a polyphenylene ether resin and an olefin resin. Accordingly, the electrically insulated wire of the present invention has excellent heat resistance and abrasion resistance and also has flame retardancy and insulation, which are basic characteristics of electric wires, without requiring large crosslinking equipment (for example, electron beam irradiation apparatus and steam pipe) in the production of the electrically insulated wire. Furthermore, the electrically insulated wire of the present invention allows wire peeling without damaging the conductor.

What is claimed is:

1. An electrically insulated wire comprising:
a conductor; and
an insulating layer having an inner layer which coats an outer circumference of the conductor and an outer layer which coats an outer circumference of the inner layer, wherein
the outer layer contains a polyphenylene sulfide resin, the inner layer contains a polyphenylene ether resin and an olefin resin, and
an average thickness of the outer layer is 50% or less of a thickness of the entire insulating layer.

2. The electrically insulated wire according to claim 1, wherein
a mixing ratio of the polyphenylene ether resin to the olefin resin in the inner layer is 20 to 80:80 to 20 by weight.

3. The electrically insulated wire according to claim 1, wherein
the average thickness of the outer layer is 50% or less and 10% or more of a thickness of the entire insulating layer.

4. The electrically insulated wire according to claim 1, wherein
the average thickness of the outer layer is 40% or less and 10% or more of a thickness of the entire insulating layer.

5. The electrically insulated wire according to claim 1, wherein
a total amount of the polyphenylene ether resin and the olefin resin contained in the inner layer is 50 mol % or more.

6. The electrically insulated wire according to claim 1, wherein
an amount of the polyphenylene sulfide resin contained in the outer layer is 50 mol % or more.

7. The electrically insulated wire according to claim 1, wherein
the polyphenylene ether resin is modified polyphenylene ether.

8. The electrically insulated wire according to claim 1, wherein
the olefin resin is polyethylene-based resin or polypropylene-based resin.
